(19) United States
(12) Patent Application Publication
(10) Pub. No.: US 2007/0036137 A1
(43) Pub. Date: Feb. 15, 2007

(54) Indicating presence of a contact on a communication device

(76) Inventors: Richard Mark Horner, Cary, NC (US); Jeffrey Scott Bardsley, Durham, NC (US)

Correspondence Address: SCENERA RESEARCH, LLC, 111 Corning Road, Suite 220, Cary, NC, 27518, US

(21) Appl. No.: 11/193,168

(22) Filed: Jul. 29, 2005

(51) Int. Cl. H04L 12/16

(52) U.S. Cl. 370/352; 370/259

(57) ABSTRACT

The present invention provides a method for indicating presence of a contact on a communication device. Aspects the preferred embodiment include associating an identifier of the contact with a speed dial control on the communication device; using the identifier to obtain presence information associated with the contact during operation of the communication device; and using a characteristic of the speed dial control to indicate the presence information associated with the contact

### FIELD OF THE INVENTION

The present invention relates to a method and system for indicating presence of a contact on a communication device.

### BACKGROUND OF THE INVENTION

Methods for displaying the presence status on the display of a mobile telephone are known. As described in US Patent Application Publication 2004/0127253A1, a presence service is one in which a presence computer or presence server is used to monitor characteristics of selected communications subscribers. These characteristics, which may be referred to as presence status, include for example the respective current accessibility via telephone, written short messaging (SMS), or e-mail. In order to indicate subscribers in which a specific user wishes to receive information about such presence characteristics, the respective user sends a monitoring or watcher list to the presence server. The watcher list contains an enumeration of the people who are of interest to the user and are to be monitored. Depending on the content of the watcher list, the presence server sends presence data to a communications terminal, such as a mobile telephone, of the user about the people or appliances to be monitored.

Publication 2004/0127253A1 discloses a method for displaying the presence status for a communication subscriber on a mobile telephone. After the mobile telephone receives presence data, which describes the presence status, and telephone book datastore in the mobile telephone is output to the display, the presence data is also output to the display for viewing by the user.

Although displaying presence data at the same time the telephone book data enables the user to determine the current availability of subscribers of interest from the telephone book, the prior art has the several disadvantages. One disadvantage of displaying presence data on devices such as mobile phones is that mobile devices typically have limited display capabilities due to their small size and cannot provide dedicated display real estate to presence status, which makes determining the presence of contacts difficult. Another disadvantage is that conventional methods for displaying the presence data may require multiple steps to determine the presence of a contact, requiring the user to first navigate to a contact list, and then search through the contact list to find the contact and see the presence. In addition, the user must then manually perform the necessary steps to contact the individual.

### BRIEF SUMMARY OF THE INVENTION

The present invention provides a method and system for indicating presence of a contact on a communication device. Aspects the preferred embodiment include associating an identifier of the contact with a speed dial control on the communication device; using the identifier to obtain presence information associated with the contact during operation of the communication device; and using a characteristic of the speed dial control to indicate the presence information associated with the contact. In a preferred embodiment, the characteristic of the speed dial control used to indicate presence information is illumination or backlighting. In the case of speed dial keys, for example, individual keys can be lit or made to flash to indicate the “availability” of the corresponding contacts.

According to the method and system disclosed herein, the present invention provides presence status of several contacts in a clear fashion on a small device that has limited display capabilities, even while the user is using the device for other purposes, such as during a telephone call. In addition, the present invention requires no navigation or interaction with the device to establish presence status and does not require screen area to indicate the status information.

### BRIEF DESCRIPTION OF SEVERAL VIEWS OF THE DRAWINGS

FIG. 1 is a block diagram illustrating a system for indicating presence of a contact on a communication device in accordance with a preferred embodiment of the present invention.

FIG. 2 is a flow diagram illustrating a process for indicating presence of a contact on a communication device in accordance with a preferred embodiment of the present invention.

FIG. 3 is a diagram illustrating an example communication device for use in accordance with the present invention.

### DETAILED DESCRIPTION OF THE INVENTION

The present invention relates to indicating presence of a contact on a communication device. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and system for using a communication device to indicate to a user of the device whether any of the user's contacts are available for communication. More specifically, a characteristic of the speed dial controls, such as the backlighting of speed dial keys, is used to indicate whether the contact associated with each key is currently available. In a preferred embodiment, this is accomplished by providing the communication device with an application that associates an identifier of a contact (e.g., presence URL, email address, or telephone number) with the speed dial key information, reads the identifier associated with the speed dial key during operation of the device, and uses the identifier to determine the presence status of the contact by requesting presence information, such as from a presence service, for example. The application then uses a characteristic of the speed dial key, such as illumination, to indicate the presence status of the contact to a user of the device.

In response to the user activating the key (e.g., by pressing the same speed dial key), the application opens a communication channel to the contact. As an example, assume that a user of a mobile phone looks at the keypad and sees that key 1 is illuminated green, but all the others are not illuminated. Assuming that key 1 is the speed dial key for the user's mother, then the green light informs the user that his mother is available, and can press-and-hold key 1 to dial her.

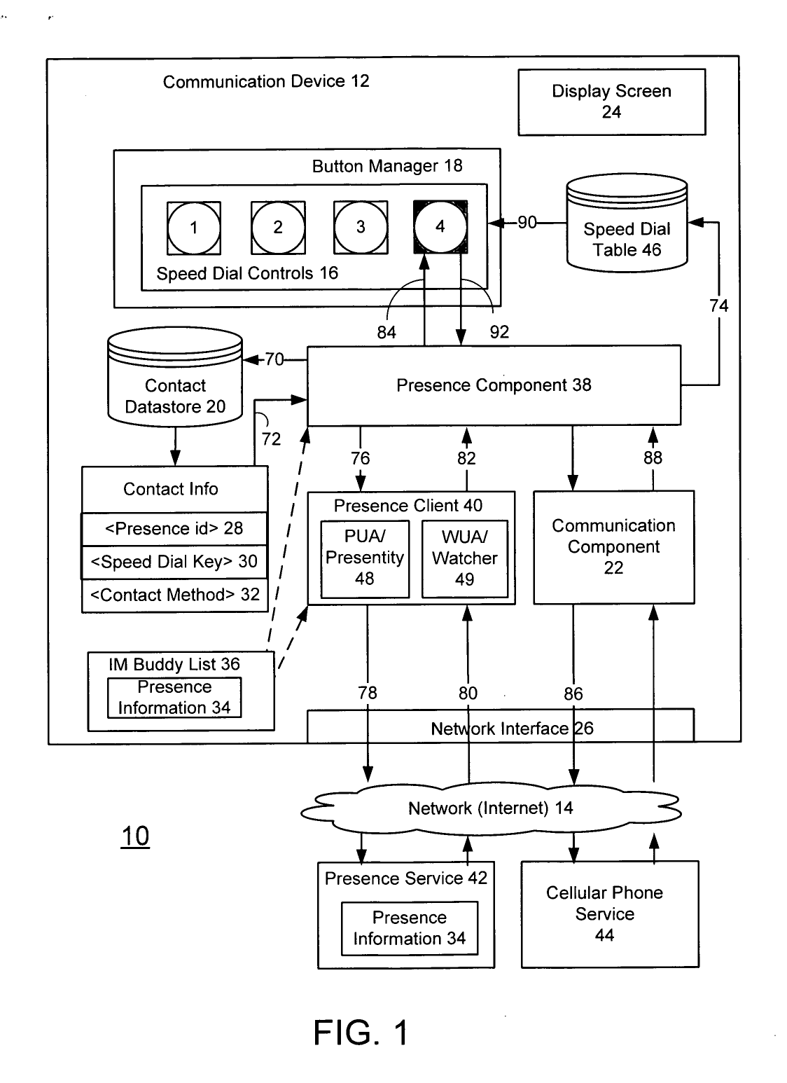

FIG. 1 is a block diagram illustrating a system for indicating the presence of a contact on a communication device in accordance with a preferred embodiment of the present invention. The system 10 includes a communication device 12 that is capable of wired and/or wireless communication over a network 14, such as the Internet, and also capable of executing software applications. The communication device 12 may be any type of mobile or desktop communication device, including a cell-phone, PDA, web-enabled digital camera, PC, laptop, scanner, facsimile or kiosk, for example. The communication device 12 includes speed dial controls 16, a button manager 18, a contact datastore 20, a communication component 22, a display device 24, and a network interface 26.

As is well-known, speed dial is a built-in feature of electronic devices (e.g., phones) that enables a user to define dialing or connection shortcuts for any stored contact. The speed dial controls 16 are part of the device's 12 user interface for implementing the dialing/connection and speed-dial functions, and are preferably implemented via a keypad that includes a plurality of keys/buttons. The speed dial control 16 may also be implemented via a standard keyboard (integrated or detached), such as a keypad portion of a computer keyboard, or via a set of dials or other controls apart from the key pad or keyboard. The speed dial function typically allows a user to activate a portion (e.g., one or two controls) of the controls that are part of the user interface for implementing the device's 12 dialing/connection function. Although the speed dial function is described throughout this document in the familiar context of a telephone user interface, other user interfaces capable of incorporating the speed dial function are within the scope of what is described here.

Using a keypad or keyboard of the device 12, a user may enter contact information for each contact, which is stored as a record in the contact datastore 20. The contact information may also be imported into the device 12. The contact datastore 20 may take many forms, such as an address book, contact list, buddy list, a speed dial list, and the like. The contact information for each contact listed in the contact datastore 20 may include a presence ID 28, an ID of the speed dial control 30 to which the contact is associated, and contact means 32 including telephone numbers, e-mail addresses, URLs, and postal addresses, for instance.

As with any speed dial feature, speed dial numbers may be automatically assigned to the contact as they are entered into the contact datastore 20. However, the user may also program the speed dial numbers. The user can then use the speed dial feature to call contact entries 1 through 9 with the push of a single key by pressing and holding the one-digit speed dial number for one second. Alternatively, the user may enter the one-, two-, or three-digit speed dial number for the entry, press the “#” key to submit the number, and then press the “SND” key to dial the telephone number associated with the contact entry. As will be at appreciated by those with ordinary skill in the art, the communications device 12 may implement the speed dial function in a manner different than described above without departing from the scope of the present invention.

The computing device 12 also preferably includes a speed dial table 46 for storing a mapping between the speed dial controls 16 and the contacts in the datastore 20. Each entry in the speed dial table 46 includes a contact ID, the speed dial control ID 30 assigned to the identified contact, and attribute settings for the identified speed dial control 16. According to the preferred embodiment, each speed dial control 16 includes at least one characteristic that can be altered by the button manager 18. Examples of speed dial control characteristics include illumination and heat, for instance. The illumination of the speed dial controls may be implemented by the built-in backlighting feature of the device 12. Illumination attribute settings for each speed dial control 16 may specify the color, flash rate, and flash duration, for example. Heating the speed dial controls 16 may be implemented by coupling heating elements to each of the speed dial controls 16. Attribute settings for heat may specify the intensity of the heat, for instance. Other characteristics may also be provided for the speed dial controls 16 without departing from the scope and spirit of the present invention.

The button manager 18 may include a combination of software and hardware that control the speed dial controls 16 and other keys and buttons of the device 12. The button manager 18 accepts input from the speed dial controls 16 and other keys and buttons, and controls characteristics of the speed dial controls, such as backlighting. Although in a preferred embodiment, the speed dial controls 16 are implemented in hardware, the speed dial controls 16 may also be implemented as soft keys that are displayed on the display device 24.

The network interface 26 provides physical access to the network 14. Example types of network interfaces 26 include Ethernet, wireless, or a dial-up connection, and may access the network 14 through a LAN or WAN. The communication component 22 provides for external communication, such as via Global Systems for Mobile Communication (GSM), Public Switched Telephone Network (PSTN), Voice and Video Conferencing Over Internet Protocol (VVOIP), chat, and so on. In the embodiment where the communication device 12 includes cellular phone capabilities, the communication component 22 interfaces with a cell phone service 44.

According to the preferred embodiment, the communication device 12 is further provided with a presence component 38 and an optional presence client 40. The presence component 38 is an application (e.g., executable, Java application, or operating system component) that obtains presence information of contacts that are associated with a speed dial ID 30, and uses at least one characteristic of the speed data controls 16 to indicate the presence information (preferably presence status) of the contacts

The presence client 40 publishes the presence information of the user of the communication device 12 to a presence service 42, and receives the presence information 34 of other contacts from the presence service 42. Although the presence component 38 and the presence client 40 are shown as separate applications, one of ordinary skill in the art will readily recognize the functionality provided by the presence component 38 and the presence client 40 may be included in a single application. The presence client 40 may include a presentity 48 and a watcher 49.

As described in A Model for Presence and Instant Messaging (RFC 2778) and Instant Messaging/Presence Protocol Requirements (RFC 2779) published by the IMPP WG (February 2000), the presentity 48 is a type of presence client that provides the presence information 34 (e.g., “online” or “offline”) of other principals (i.e., real-world objects such as people or programs) that have presence information associated with them to the presence service 42. A principal is indirectly associated with a presence uniform resource identifier (URI) or uniform resource locator (URL), (collectively referred to herein as the presence ID 28), via the principal's presentity 48. The presence information 34 supplied to the presence service 16 includes the status of a user of the presence service 42 and may include additional information used by the presence service. This additional information can include, for example, the preferred communication means, e.g., telephone or email, and corresponding contract address, e.g., telephone number or email address) of the user.

The presence information 34 can be stored or maintained in any form for use by the presence service, but typically is organized into portions referred to as presence tuples. As will be understood by those skilled in the art, a tuple, in its broadest sense, is a data object containing two or more components. Each presence tuple may include a status that conveys status information (such as online, offline, busy, away, do not disturb) of a particular principal/presentity (e.g., user), an optional communication address, and optional other presence markup. A communication address includes a contact means and a contact address. One type of contact means is instant message service, where the corresponding contact address is an instant inbox address. However, a contact means may might also indicate one or more of the following: some form of telephony, for example, with a corresponding contact address containing a telephone number; email communications with a corresponding contact address containing an email address; or a physical mail with a corresponding contact address containing a postal address. Thus, broadly speaking, the presence information includes general contact information for the principal, such as name, telephone number, email address, postal address, and IP addresses or URLs associated with the object, and the like. As used herein, if the presence information 34 associated with an object does not include a status, then the presence information 34 returned from the presence service 42 may be just current contact information, such as present location.

A second type of presence client is the watcher 49. The watcher 49 receives presence information from the presence service 42. The presence model of RFC 2778 describes types of watchers, referred to as “subscribers” and “fetchers.” A subscriber requests notification from the presence service of a change in some presentity's presence information. The presence service 42 establishes a subscription on behalf of the subscriber to a presentity's presence information, such that future changes in the presentity's presence information are “pushed” by the presence service 16 to the subscriber. In contrast, the fetcher class of watchers requests (or fetches) the current value of some presentity's presence information from the presence service. As such, the presence information can be said to be “pulled” from the presence service 16 to the presentity. A special kind of fetcher, referred to as a “poller,” is defined in the model as one that fetches information on a regular (or polling) basis. According to the general presence model described in RFC 2778, a principal can interact with the presence system through a presence user agent (PUA) or a watcher user agent (WUA). It will be understood that while the model describes the presentity 48 and watcher 49 as separate entities, these entities can be combined functionally as a single presence entity having the characteristics of both a presentity and a watcher.

While the various presence service and presence protocol embodiments used today have differences, all of these embodiments use presence architectures and protocols that are consistent with the presence model and protocols described in RFC 2778 and RFC 2779 in terms of features and function. Accordingly, the terms used here should not be limited to any one of the presence models, services, and/or protocol embodiments in use today.

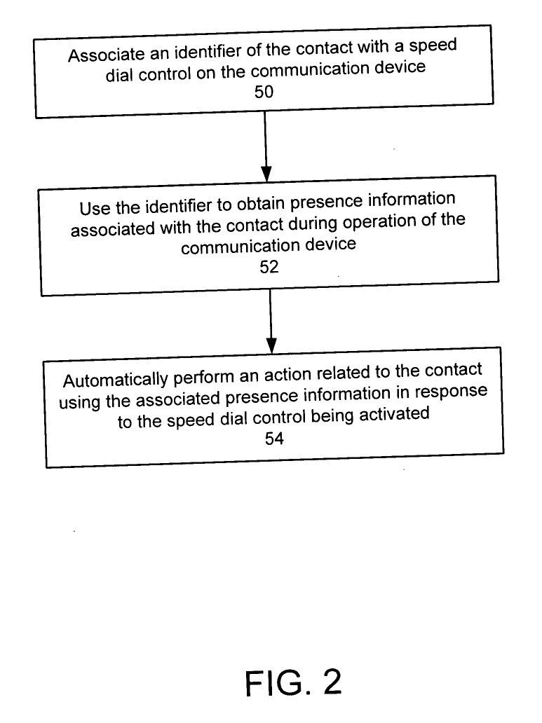

FIG. 2 is a flow diagram illustrating a process for indicating presence of a contact on a communication device in accordance with a preferred embodiment of the present invention. Referring to both FIGS. 1 and 2, the process begins in step 50 by associating an identifier of the contact with a speed dial control 16 on the communication device 12. In a preferred embodiment, the identifier 22 is a means of indicating a point of contact that is stored in the contact datastore 20. Names, telephone numbers, email addresses, postage address, and typical home page URLs are all examples of identifiers. However, in an alternative embodiment, in some business contexts, the identifier 22 may include information that is not intended for the public, such as employee and account numbers. In a preferred embodiment, the identifier is a presence ID 28. One example of a presence ID is a username that is used in an email address in a service that offers a chat service. For example, in the example YAHOO email address “abc@yahoo.com”, the presence ID of the user for instant messaging is simply “abc”.

In the preferred embodiment where the communication device 12 includes contact information for multiple contacts that are associated with speed dial controls 16, the process of associating the identifier of each of the contacts with one of the speed dial controls 16 may be accomplished indirectly by associating the presence ID 28 with the contact information of the contact, rather than with one of the speed dial controls.

After the identifier of the contact is associated with one of the speed dial controls 16, in step 52 the presence component 28 uses the identifier to obtain presence information 34 associated with the contact during operation of the communication device 12.

In a preferred embodiment, the presence component 38 uses the identifier to obtain presence information for the corresponding contact as described below. The following steps assume the user has configured the communication device 12 such that the contacts in the contact datastore 20 have previously authenticated each other to allow access to their presence information 34 by their watchers 49. The configuration for a contact may include populating the contact information with the presence id 28 (to determine the presence status etc), the associated speed dial key ID 30 (to determine which the controls/keys to alter) and contact means 30 to (to open a communication channel to the contact).

Referring to FIG. 1, when the device 12 is booted, or at some scheduled time, the presence component 38 scans the contact datastore 20 via a line 70 and retrieves any contacts that are associated with a speed dial ID 30 via line 72. The presence component 38 reads the presence ID 38 and the speed dial ID 30 for the contact. If the contact does not include a presence ID 38, then the presence component 38 reads another identifier used to identify the contact. The presence component 38 stores or updates the speed dial table 46 with the speed dial control mappings and sets the speed dial control attributes for each speed dial control 16 via line 74. The speed dial control attributes for the entries in the speed dial table 46 may be preconfigured, configured by the user, or determined by the type of presence tuple to be watched based on the presence ID 28. For each entry in the speed dial table 46, the presence component 38 determines the most appropriate method to obtain presence information 34 associated with the presence ID 28 based on the communication device configuration and the type of presence ID 28.

If the presence ID 28 is a type sufficient to directly obtain the presence information (e.g., is a presence URL), in one embodiment, the presence component 38 sends the identifier 22 to the presence client 40 via line 76, and the presence client 40 uses the presence ID 28 to subscribe to the presence service 42 via line 78 to obtain the presence information 34 via line 80. In this embodiment, the presence information 34 preferably includes presence status and/or contact information, as explained above. After the watcher 49 receives the presence information 34, the presence client 40 passes the presence information 34 to the presence component via line 82. The presence component 38 then provides the presence ID 28 and presence status to the button manager 18 via line 84.

In a second embodiment, the presence component 38 retrieves the presence information 34 associated with the presence ID 28 from an entry in a local presence roster list 36, such as an IM buddy list, rather than from the presence service 42. In this embodiment, the presence information 34 returned from the presence roster list 36 would be the presence status of the contact (e.g., “online”). Alternatively, the presence client 40 may query the presence roster list 36 with the presence ID 20 to obtain the presence information 34.

If a contact does not have a presence ID 28, then the presence ID 28 may be obtained in directly from another identifier for the contact. In this case, the identifier is used as an index to obtain the presence ID 28 (e.g., presence URL) via a look-up or mapping operation, and the presence ID 20 is then used to obtain the presence information 34, as explained above. For example, if the identifier is a telephone number or name, then the telephone number or name can be mapped to an email address, which is a sufficient type of presence URL to obtain the presence information 34. Likewise, if the identifier 22 is an address, then the address can be used to obtain a name or telephone number, which can then be used to obtain the presence ID 20.

In a third embodiment, the presence component 38 may obtain the present location of one or more contacts without obtaining presence information 34. This may be accomplished using a GPS device in the computing device 12. Alternatively, the presence component 38 may pass the cell phone number of the contact to the cell phone service 44 using communication component 22 via line 86. As those with ordinary skill in the art will appreciate, cell phone service 44 may use cell tower triangulation to determine the current location of the contact's communication device, and pass the location information back to the presence component via line 88.

Referring again to FIG. 2, after the presence component receives the presence information 34 for contacts associated with the speed dial controls 16, at least one characteristic of the speed dial controls 16 is used to indicate the presence information 34 associated with the corresponding contacts. In a preferred embodiment, the characteristics of the speed dial control are used to indicate the presence status of the corresponding contact, but may also be used to indicate proximity of the contacts in relation to the current location of the device 12.

In a preferred embodiment, the characteristic of the speed dial control used may differ depending on whether the speed dial controls 16 are implemented in hardware (e.g., keys, buttons, or dials), or are implemented as soft keys. For hardware-based speed dial controls 16, the characteristics may comprise illumination or heat. Texture may also be a characteristic that could be used if technology is available for altering the texture of a key/button/dial during operation of the device 12. For soft key speed dial controls 16, the characteristics may comprise size, shape, color, or fill pattern, for instance.

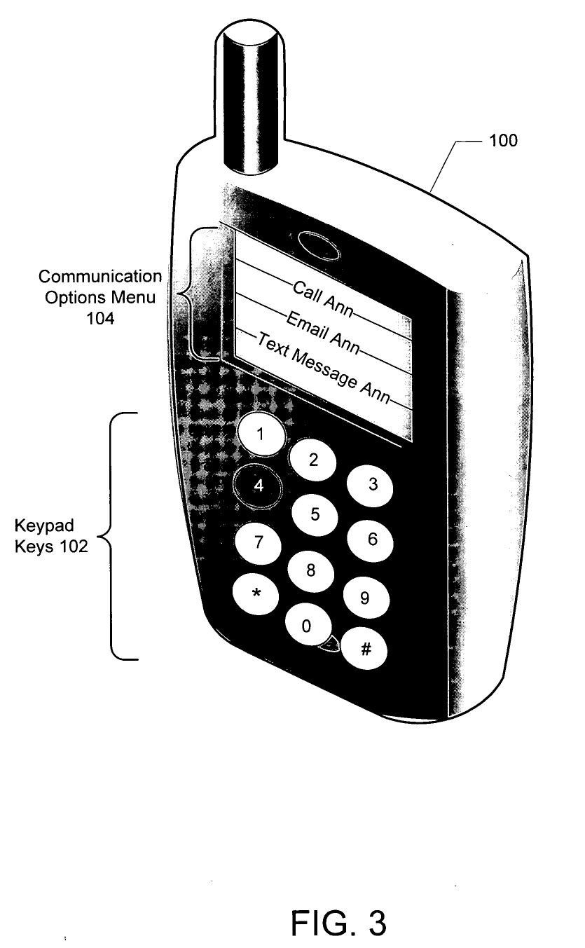

FIG. 3 is a diagram illustrating an example communication device for use in accordance with the present invention. In this example, the communication device is a cell phone 100 and the speed dial controls 16 comprise the cell phone keypad keys 102. The cell phone 100 has received the presence information for its contacts and the contact associated with speed dial key “4” has a presence status of “available”, while the contacts associated with the other speed dial keys are currently unavailable. Accordingly, the cell phone 100 illuminates the speed dial key “4” to indicate the available presence status of the contact to the cell phone user. Thus, the illumination of the speed dial keys 102 is used to indicate the presences status of the contacts, and the user may configure the illumination attributes as desired to include any combination of color, flash rate, and flash duration.

In further aspects of the present invention, the presence ID 30 of more than one contact may be associated with a single speed dial control 16. In this case, the speed dial control 16 may be configured to display different colors for the different contacts. The speed dial controls 16 may be also configured to be illuminated with a color indicating that the contacts associated with the speed dial controls 16 are currently in communication with each other.

Referring again to FIG. 2, after a characteristic of the speed dial control 16 is used to indicate the presence information associated with the contact, in step 54, an action related to the contact is automatically performed using the associated presence information in response to the speed dial control 16 being activated. In a preferred embodiment, actions that may be automatically performed include the opening of a communication channel, or the storage of a reminder relating to the contact, for example. The communication channel may be opened via a communication address included in the presence information 34 associated with the contact or via a communication address included in the contact information. Example types of communication channels include dialing a telephone number associated with the contact, opening an e-mail message addressed to the contact, and opening a text message addressed to the contact.

In one embodiment, a default type of communication channel is opened when the speed dial control 16 is activated. In another embodiment, a menu of available communication channel choices is displayed on the display 24 for user selection in response to the speed dial 16 control being activated.

Referring again to FIG. 3, for example, assuming the user presses the illuminated “4” key, a communication options menu 104 may be displayed. The user may scroll down the list and select one of the communication channel choices. In response, the phone 100 may automatically open the selected channel option. In one embodiment, the user may configure the communication options menu 104 and control which options are displayed, establish a default to indication channel, and/or prioritize the communication channel options.

In a further embodiment, the user may simultaneously activate more than speed dial control 16, which may cause the device 12 to initiate simultaneous communication channels with the corresponding contacts, where simultaneous refers to opening a communication channel or channels to the contacts at substantially the same time through a shared channel or separate channels. Examples of shared channels include establishing a conference call, or IM, or text messages addressed to the respective contacts, while an example of a shared channel includes opening multiple email windows addressed to the contacts.

In another embodiment, once the presence component 38 receives the presence information 34 for the contacts associated with the speed dial controls, the presence component 38 may compare the current location of the device 12, which may be determined by GPS, with the current locations of the devices associated with the contacts. The presence component 38 may then illuminate the speed dial controls 16 in a manner that indicates which contact's devices are currently in proximity to the communication device 12. As stated above, the location of devices belonging to the contacts may be determined by obtaining the location through the cell service 44, which may either receive GPS location information from the devices, or use cell tower to determine their locations.

Referring again to FIG. 1, the details of how the characteristics of the speed dial controls 16 are used to indicate the presence status associated with the contacts will now be described. The process begins once the button manager 18 receives the presence information 34 from the presence component 38 via line 84. In response, the button manager 18 determines which speed dial controls 16 to update based on the speed dial control/contact mappings in the speed dial table 46 via line 90. The button manager 18 sets the characteristic of the speed dial controls 16 based on the attribute settings in the speed dial table 46. For illumination for example, the button manager 18 may set the color and flash duration based on the status of the corresponding contact, as specified by the attribute settings.

After the characteristics of the speed dial controls 16 are updated accordingly, the user of the device 12 sees the “available” presence status for a contact via the characteristic of one of the speed dial controls 16 (e.g., a green or flashing key 4) and decides to contact them. The user presses the speed dial control 16 (e.g., key 4) via line 92. In response, the button manager 18 sends the speed dial ID 30 for the speed dial control 16 to the presence component 38. The presence component 38 uses the speed dial ID 30 to find the contact entry in the contact datastore 20, or in the presence information 34 returned for the contact, and reads the contact means 32 from the contact entry. Based on default settings or user selection, the presence component 38 attempts to open a communication channel via one or more of the contact addresses in the contact means.

Several user scenarios are provided below to further illustrate operation and advantages of the system 10 for associating presence information 34 with digital images 20.

Scenario 1

Michael is taking a coffee break and glances at his phone. His mobile phone has ten speed dial keys that are used for speed dial and presence. He has assigned each key to a contact and entered a telephone number and presence ID (email address i.e. mum@hotmail.com or presence URL). A mobile phone application (e.g., presence component) requests the presence status for all the contacts assigned to the speed dial keys from the presence application, which connects to the presence service to check the status. The returned presence status is then communicated by illuminating the associated speed dial key. He sees that key 1, which is assigned to his mother, is illuminated green indicating her presence status is “Available”. So he holds down key 1 and the phone dials her telephone number, she picks up and they talk.

Scenario 2

Michael needs to speak to both John and Jeff. He glances at his watch phone and sees Key 1 is illuminated which means John is “Available” and key 2 is not illuminated which means Jeff is “Not Available”. Also key 3 is illuminated orange which means that either John or Jeff are “Available”, but not both. A minute later he glances at the phone and sees that keys 1, 2 and 3 are illuminated green. Because he needs to contact both John and Jeff he presses key 3 which creates a conference and calls both John and Jeff. John is using his computer, so a voice and video call is created and Jeff is using his mobile phone, so he is connected by voice only. Michael, John and Jeff proceed to talk.

Scenario 3

Michael has a mobile phone in which the attribute settings are configured to indicate the proximity of contacts. Fast flashing indicates the contact is within 1 mile, slow flashing indicates the contact is within 5 miles, and no flashing indicates the contact is over 5 miles away. Michael is talking with his sister Jane on his mobile phone and notices that key 1 on his mobile is flashing green quickly. From this he knows that his mother is “Available” (illuminated green) and is within 1 mile of his current location. He presses the speed dial key 1 which calls his mother and conferences her in. Michael, his sister and mother talk and decide to meet for lunch as they are all located near each other.

Scenario 4

Michael has a mobile phone in which the attribute settings are configured to illuminate the speed dial keys blue of two contacts who are communicating via instant messaging. Michael looks at his mobile phone and sees that key 1 and 2 are both illuminated blue. From this he can tell that his mother (key 1) is communicating with his father (key 2) using instant messaging (blue color). Remembering that he needs to chat with them both he presses both key 1 and 2 simultaneously. Michael's phone attempts to join the chat session between his mother and father by sending a request. His mother and father accept the request and Michael joins the chat session.

Scenario 5

Jane is on vacation skiing, so she configures the presence on her mobile phone with her contact communication addresses and their associated priority. She sets telephone communication as priority one, IM as priority two and SMS as priority three, as her ski gloves make it difficult to use the keyboard compared to talking on the telephone.

Michael looks at his mobile phone and sees that key 1 is illuminated green. From this he can tell that his sister Jane is “Available”. He presses key 1 for a second, which indicates to the phone that he wishes to communicate with Jane. The phone inspects the presence information from Jane and picks the highest priority contact communication address. As priority one is telephone the phone uses that method and the telephone number included in the presence information to call Jane. Jane has her phone set to auto answer and so talks with her brother using the Bluetooth ear piece that is integrated into her ski hat as she skis.

Scenario 6

Bob and Alice are brother and sister, Bob lives in San Jose, CA, and Alice lives in Raleigh, NC. Both are busy working for high tech companies and rarely get to see each other but they do sometimes visit the same cities while traveling on business. Unfortunately, it is always after the fact that they learn about one another being in the same city at the same time. To keep this from happening in the future, both enroll in a new service offered by the mobile phone company which can alert them that they are close in proximity and have their mobile phones active. The service detects that they are near each other by the cell towers within range of their mobile phones.

A few months later, Bob is sent on assignment to Las Vegas, NV. He turns on his mobile phone soon after his flight arrives at McCarran airport. The key pad flashes on and off for a few seconds and then the button that he assigned to alert him about his sister stays backlit. At the same time, Alice's mobile phone key pad flashes and the key button that she assigned to alert her about Bob stays illuminated. Bob presses the key button and releases it which initiates a menu on his display screen. The display menu gives Bob the choice of sending a text message by pressing the same button twice in rapid succession or initiating a call by continuing to hold the button down. Bob presses the key and holds it down until a call to Alice is initiated.

A method and system for indicating presence information, including presence status, of a contact on a communication device has been disclosed. The present invention provides several advantages. First, the present invention is very intuitive to how people think, i.e., looking at a mobile device, seeing that someone is available and using speed dial to contact them. The present invention provides presence status of several contacts in a clear fashion on a small device that has limited display capabilities even while the user is using the device for other purposes, such as during a telephone call. In addition, the present invention requires no navigation or interaction with the device to establish presence status and does not require the use of any screen area.

The present invention has been described in accordance with the embodiments shown, and one of ordinary skill in the art will readily recognize that there could be variations to the embodiments, and any variations would be within the spirit and scope of the present invention. For example, the viewer may be required to be authenticated before obtaining presence information (e.g., by entering a username and password). Accordingly, many modifications may be made by one of ordinary skill in the art without departing from the spirit and scope of the appended claims.

We claim:

1. A method for indicating presence of a contact on a communication device, comprising:
associating an identifier of the contact with a speed dial control on the communication device;
using the identifier to obtain presence information associated with the contact during operation of the communication device; and
using a characteristic of the speed dial control to indicate the presence information associated with the contact.

2. The method of claim 1 wherein using a characteristic of the speed dial control to indicate the presence information of the contact includes illuminating the speed dial control based on the presence information to indicate whether the contact is available for communication.

3. The method of claim 1 further including: in response to the speed dial control being activated, performing an action related to the contact using the associated presence information.

4. The method of claim 3 further including: in response to the speed dial control being activated, opening a communication channel via a communication address included in the presence information associated with the contact.

5. The method of claim 4 wherein opening a communication channel further includes one of dialing a telephone number associated with the contact, opening an e-mail message addressed to the contact, opening an instant messaging system, and opening a text message addressed to the contact.

6. The method of claim 4 further including: in response to the speed dial control being activated, displaying a menu of available communication channel choices included in the presence information on the communication device for user selection.

7. The method of claim 4 further including: allowing the communication channel choices to be prioritized, including establishing a default communication channel.

8. The method of claim 1 wherein the communication device includes multiple speed dial controls, the method further including: associating multiple identifiers of multiple contacts with respective multiple ones of the speed dial controls, and using a characteristic of at least one of the speed dial controls to indicate the respective presence information of the multiple contacts.

9. The method of claim 8 further including: associating more than one of the identifiers with a respective one of the speed dial controls, such that activating the respective speed dial control initiates a substantially simultaneous action among the contacts associated with the identifiers and the respective speed dial control.

10. The method of claim 8 wherein using a characteristic of at least one of the speed dial controls includes illuminating two of the speed dial controls with a color indicating that two contacts associated with the speed dial controls are currently in communication with each other.

11. The method of claim 1 wherein using a characteristic of the speed dial control to indicate the presence information associated with the contact further includes using illumination attributes to indicate a status of the contact, wherein the illumination attributes include any combination of color, flash rate, and flash duration.

12. The method of claim 11 further including: using user configurable rules to determine the illumination attributes and communication channel choices.

13. The method of claim 1 wherein using the identifier to obtain the presence information associated with the contact further includes using the identifier to retrieve the presence information associated with an entry included in a local roster list corresponding to the identifier.

14. The method of claim 1 wherein using the identifier used to obtain the presence information associated with the contact further includes using the identifier to subscribe to the presence information associated with the contact via a presence service.

15. The method of claim 1 wherein the identifier comprises a presence URL.

16. The method of claim 15 wherein the identifier comprises contact means, and the contact means is used to determine the presence URL via a lookup operation.

17. The method of claim 1 wherein using the identifier to obtain the presence information associated with the contact further includes determining a current location of a communication device associated with the contact, and using a characteristic of the speed dial control to indicate that the contact's communication device is currently in proximity to the communication device.

18. The method of claim 17 further including: using cell tower triangulation to determine the current location of the contact's communication device.

19. The method of claim 17 further including: using GPS to determine the current location of the contact's communication device.

20. A communication device for indicating presence of a contact, comprising:
a contact datastore for storing contact information for a plurality of contacts, wherein each of the contacts is identified by an identifier;
a plurality of speed dial controls; and
a presence component for,
associating the identifiers of the contacts with the speed dial controls,
using the identifiers to obtain presence information associated with the contacts during operation of the communication device; and
using a characteristic of the speed dial controls to indicate the presence information associated with the at least a portion of the contacts.

21. The communication device of claim 20 wherein the characteristic of the speed dial controls used to indicate the presence information comprise illumination.

22. The communication device of claim 20 wherein in response to the speed dial control being activated, an action is performed related to the contact using the associated presence information.

23. The communication device of claim 22 further including: in response to the speed dial control being activated, a communication channel is opened via a communication address included in the presence information associated with the contact.

24. The communication device of claim 23 wherein opening a communication channel further includes one of dialing a telephone number associated with the contact, opening an e-mail message addressed to the contact, opening an instant messaging system, and opening a text message addressed to the contact.

25. The communication device of claim 23 wherein in response to the speed dial control being activated, a menu is displayed of available communication channel choices included in the presence information on the communication device for user selection.

26. The communication device of claim 23 wherein the presence component enables a user of the communication device to prioritize the communication channel choices, including establishing a default communication channel.

27. The communication device of claim 20 wherein the presence component associates multiple identifiers of multiple contacts with respective multiple ones of the speed dial controls, and uses a characteristic of at least one of the speed dial controls to indicate the respective presence information of the multiple contacts.

28. The communication device of claim 20 wherein the presence component associates more than one of the identifiers with a respective one of the speed dial controls, such that activating the respective speed dial control initiates a substantially simultaneous action among the contacts associated with the identifiers and the respective speed dial controls.

29. The communication device of claim 28 wherein the presence component is configured to use a characteristic of at least one of the speed dial controls by illuminating two of the speed dial controls with a color indicating that the two contacts associated with the speed dial controls are currently in communication with each other.

30. The communication device of claim 20 wherein the communication device includes a speed dial table for storing a mapping between the speed dial controls and the contacts in the contact datastore, wherein each entry in the speed dial table includes a contact ID, a speed dial control ID assigned to the identified contact, and attribute settings for the speed dial controls.

31. The communication device of claim 30 wherein the attribute settings include any combination of color, flash rate, and flash duration.

32. The communication device of claim 31 wherein user configurable rules are used to determine the attribute settings and communication channel choices.

33. The communication device of claim 20 wherein when the presence component uses the identifier to obtain the presence information associated with the contact, the presence component uses the identifier to retrieve the presence information associated with an entry included in a local roster list corresponding to the identifier.

34. The communication device of claim 20 wherein when the presence component uses the identifier used to obtain the presence information associated with the contact, the presence component uses the identifier to subscribe to the presence information associated with the contact via a presence service.

35. The communication device of claim 20 wherein the identifier comprises a presence URL.

36. The communication device of claim 35 wherein the identifier comprises contact means, and the contact means is used to determine the presence URL via a lookup operation.

37. The communication device of claim 20 wherein when the presence component uses the identifier to obtain the presence information associated with the contact, the presence component determines a current location of a communication device associated with the contact, and uses a characteristic of the speed dial control to indicate that the contact's communication device is currently in proximity to the communication device.

38. A computer readable medium containing program instructions for indicating presence of a contact on a communication device, comprising:
associating an identifier of the contact with a speed dial control on the communication device;
using the identifier to obtain presence information associated with the contact during operation of the communication device; and
using a characteristic of the speed dial control to indicate the presence information associated with the contact.

39. A method for indicating presence on a communication device, wherein the communication device includes contact information for least one contact, and wherein the contact information for the contact is associated with a speed dial control on the communication device, the method comprising:
associating an identifier with the contact information of the contact;
using the identifier to obtain the presence of the contact during operation of the communication device; and
using a characteristic of the speed dial control to indicate the presence information of associated with the contact.
